(19) United States
(12) Patent Application Publication
(10) Pub. No.: US 2005/0179270 A1
(43) Pub. Date: Aug. 18, 2005

(54) Animal waste removal device and method for using same

(75) Inventor: Kamonsak Amornlsulpittaya, Bangkok (TH)

Correspondence Address: Cheryl F. Cohen, 2409 Church Road, Cherry Hill, NJ, 08002, US

(73) Assignees: Homeware Plastics Co., Ltd.; Regent Baby Products Corp.

(21) Appl. No.: 10/778,258

(22) Filed: Feb. 13, 2004

(51) Int. Cl. A01K 29/00; E01H 1/12

(52) U.S. Cl. 294/1.3

(57) ABSTRACT

A system for removal of animal waste using a waste removal device and a disposable bag. The waste removal device including a scoop for gathering the animal droppings and a handle connected to the scoop. The handle has a cavity defined therein adapted in size and dimension to receive a plurality of unused bags, preferably formed into a roll, and a releasable closure for retaining unused bags in the cavity of the handle. In operation the animal waste removal device is inserted into an unused disposable bag until the distal end of the waste removal device is proximate a closed end of the bag. The animal waste is then scooped up by the scoop covered by the bag thereby imposing a force on the closed end of the bag retaining it against the distal end of the scoop. After the animal waste has been collected on to the scoop, the bag is turned inside out by pulling the open end of the bag over itself until the closed end of the bag thereby enclosing the animal waste therein.

### BACKGROUND OF THE INVENTION

1. Field of the Invention

The present invention is directed to an animal waste removal device and, in particular, an animal waste removal device that is inexpensive to manufacture and operate while remaining sanitary at all times.

2. Description of Related Art

Animal waste removal devices have been widely adopted over the years primarily as a result of laws and regulations requiring pet owners to properly dispose of the feces left by their pet. A wide variety of devices have been designed to aid the owner in collecting and properly disposing of animal waste droppings. The most basic of animal waste removal methods being placing a plastic bag over the user's hand and scooping up the animal waste. Thereafter, the bag is inverted over the user's hand to conceal the waste therein. This method is quite unpleasant despite the indirect contact with the animal waste. An alternative for which numerous patents have been issued is directed to a disposable scoop of varying designs and configurations. One such example is disclosed in U.S. Pat. No. 4,215,886. Despite the relative inexpensive cost for each individual disposable device, over time even such minimal costs can add up and user must periodically buy a new supply of disposable devices.

In addressing these disadvantages several recent patents such as U.S. Pat. Nos. 6,439,627; 5,564,762 and 5,222,777 have focused on employing a disposable plastic bag liner inserted into the interior or mouth of a non-disposable closed scoop for gathering the animal waste. By way of example, U.S. Pat. No. 6,439,627 discloses a closed scooping device having a closed end enclosed by walls terminating in an opposite open ended mouth and defining an interior region therein. The closed end of a disposable bag is inserted as a liner into the interior of the closed scooping device. This prevents the scoop from being soiled and having to be clean. The plastic bag is of a length sufficient to extended back over the exterior of the closed scoop to form a shield protecting the user's hand from becoming soiled while gathering the animal waste. The disadvantage associated with this patented design is that after inserting the plastic bag lining into the interior of the closed scoop, when the user pushes against the soil or ground to gather the animal waste therein the plastic bag liner advances outward from the interior of the closed scoop. Advancement of the plastic bag outward from the bottom of the closed scoop can significantly reduce the region of the plastic bag necessary for receiving the accumulated animal waste in the plastic bag. In the worst case the plastic bag liner advances to the extent that its closed end is pulled taught against the mouth of the closed scoop thereby prohibiting the animal waste from being collected in the bag. In such a situation, the user is forced with the undesirable task of having to manipulate with their other hand the plastic bag liner within the closed scoop so that its closed end is again positioned proximate the closed end of the scoop. Repositioning of the plastic bag liner as such defeats the underlying sanitary purpose of the plastic bag and scoop.

It is therefore desirable to develop an improved animal waste removal device that ensures that the scoop and the user's hand remain sanitary while overcoming the disadvantages discussed above associated with conventional devices.

### SUMMARY OF THE INVENTION

The present invention is directed to a system for removal of animal waste using a waste removal device and a disposable bag. The waste removal device including a scoop for gathering the animal droppings and a handle connected to the scoop. The handle has a cavity defined therein adapted in size and dimension to receive a plurality of unused bags, preferably formed into a roll, and a releasable closure for retaining unused bags in the cavity of the handle. In addition, the present invention also discloses a method for collecting animal waste using the animal waste removal device. The animal waste removal device is inserted into an unused disposable bag until the distal end of the waste removal device is proximate a closed end of the bag. The animal waste is then scooped up by the scoop covered by the bag thereby imposing a force on the closed end of the bag retaining it against the distal end of the scoop. After the animal waste has been collected on to the scoop, the bag is turned inside out by pulling the open end of the bag over itself until the closed end of the bag thereby enclosing the animal waste therein.

### BRIEF DESCRIPTION OF THE DRAWING

The foregoing and other features of the present invention will be more readily apparent from the following detailed description and drawings of illustrative embodiments of the invention wherein like reference numbers refer to similar elements throughout the several views and in which:

FIG. 1 is a perspective view of an exemplary animal waste removal device in accordance with the present invention with the closure to the cavity in an open position and the roll of unused disposable bags partially inserted into the cavity;

FIG. 2 is a cross-sectional view of the handle in FIG. 1 along line II-II also including the;

FIG. 3 is a perspective view of the animal waste removal device inserted into the disposable bag prior to scooping up the animal waste;

FIG. 4 is a perspective view of the animal waste removal device after having been inserted into the disposable bag while scooping up the animal waste;

FIG. 5 is a perspective view of turning the bag inside out back over itself after scooping the animal waste onto the scoop; and

FIG. 6 is a perspective view of the bag inverted inside out with the animal waste enclosed therein and ready for proper disposal.

### DETAILED DESCRIPTION OF THE INVENTION

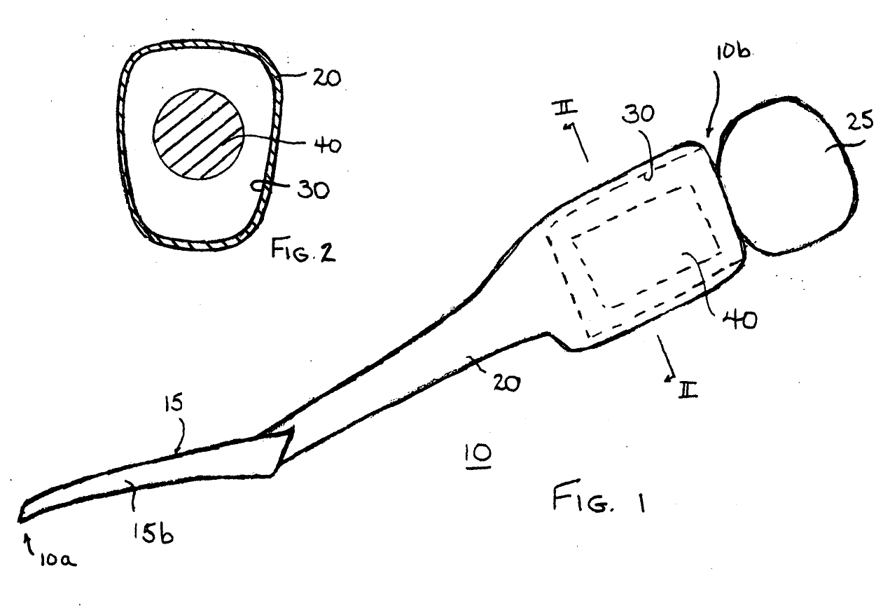

FIG. 1 is a perspective view of an exemplary animal waste removal device 10 in accordance with the present invention. The animal waste removal device 10 includes a scoop or shovel 15 to which a handle 20 is connected thereto. Scoop 15 is preferably shaped like a shovel having a substantially planar distal end 10a, however, any shape scoop that is capable of gathering the animal droppings is contemplated and within the intended scope of the present invention. The geometric shape and dimension of the scoop is not critical. Nevertheless, the scoop 15 preferably remains open in that it is formed by a bottom wall 15a (FIG. 3) onto which the animal waste material 45 is to be slid and side walls 15b extending therefrom, but does not have an upper wall, covering or overhang so that it does not form an interior region. In a preferred embodiment, the surface area defined by the bottom wall is greater than the surface area of all the side walls combined. For reasons described in detail further below, regardless of its geometric shape scoop 15 preferably terminates in a blunt distal end 10a. As shown in FIG. 2, handle 20 has a cavity 30 defined therein. Access into the cavity 30 defined in the handle 20 is via a releasable door or closure 25. The door or closure 25 is preferably secured by any conventional releasable locking mechanism such as a snap and fit enclosure. Cavity 30 terminates in the handle 20 and is not accessible via the upper surface of the bottom wall 15a of the scoop onto which the animal waste is slid.

In the exemplary embodiment shown in FIG. 1, the cost of manufacture is minimized by manufacturing the animal waste removal device 10 including the door or closure 25 as an integral unit preferably made from a molded polymer. This method of manufacture is inexpensive in that it eliminates the need for assembling separate parts. In this preferred embodiment, the door or closure 25 remains attached to the handle 20, however, the connection therebetween is sufficiently thin as to permit the door or closure 25 to be displaced by the user between a first position in which the door or closure 25 covers the open proximal end 10b of the handle 20 and a second position in which the door or closure 25 is displaced so as to allow the placement and removal of contents in the cavity 30.

Cavity 30 stores unused disposable bags, preferably in the form of a roll of unused disposable plastic bags 40. It is, however, contemplated and within the intended scope of the invention to use bags manufactured from any other type of disposable material such as paper. It is preferred that the unused bags be formed in a roll to minimize the amount of storage space necessary, thereby increasing the number of bags able to be stored in the cavity 30. Instead of being wound in a roll, the unused bags may be stuffed one at a time into the cavity 30. Cavity 30 is of a dimension, shape and size to accommodate at least one, but preferably, a roll of unused disposable bags for collecting the animal waste. The bags may be dispensed from the cavity 30 by releasing and opening the closure 25 to insert/remove the bags therefrom one at a time. Alternatively, or in addition thereto, an aperture 35 may be defined through the exterior of the handle 20 in communication with the cavity 30 to permit the bags to be dispensed one at a time therethrough without having to open the door or closure 25 each time. The location of the aperture 35 may be positioned, as desired, anywhere in the handle so long as it is in communication with the cavity 30. Each bag 40′ is preferably dimensioned substantially equal to that of the animal waste disposal device 10. Alternatively, each bag should at least be substantially dimensioned so that the scoop 15 may be inserted therein. Preferably, the bag 40′ is sufficiently long to extend up at least a portion of the handle 20 so that the user can retain the open end of the bag while grasping the handle 20 to scoop up the animal waste. Otherwise, the user will have to simultaneously grasp an edge of the open end of the bag 40′ while grasping the handle 20 to scoop up the animal waste. The distal end 10b of the animal waste removal device 10 is preferably blunt, e.g., having a planar edge as shown in FIG. 1, to minimize the risk of puncturing or tearing of the closed end of the bag with the animal waste removal device inserted therein while sliding the animal waste onto the scoop.

In operation, at least one unused bag 40′, preferably a roll of a plurality of unused disposable bags 40, are inserted into the cavity 30 and the closure 25 is secured shut thereby preventing the bags from dropping out from the cavity 30. The refilling of unused disposable bags is performed once a week, once every two weeks or as needed. This is advantageous in that it eliminates having to locate a disposable bag prior to taking your pet for a walk or inadvertently running out of disposable bags during you walk. Prior to scooping up the animal waste droppings, a single bag 40′ is removed from the handle 20 by opening the closure 25 and then unwinding and tearing off a bag from the roll 40. Thereafter, the remaining roll 40 of unused bags may be returned to the cavity 30 and the door or closure 25 secured shut. In an alternative embodiment, in which the handle 20 has a dispensing aperture 35 defined therethrough and in communication with the cavity 30, a single bag 40′ may be dispensed from the cavity 30 by pulling a loose end of the bag 40′ through the aperture 35 and tearing it off from the roll 40.

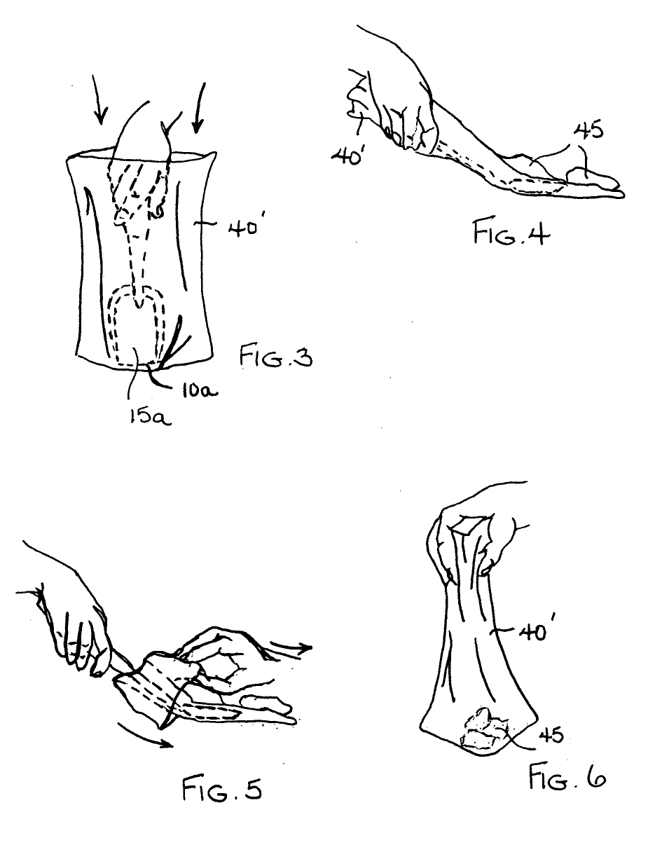

After being removed from the cavity 30, the unused disposable bag 40′ is opened and the distal end 10b of the animal waste removal device 10 is inserted into the closed end of the bag 40′, as shown in FIG. 3. Referring to FIG. 4, the open end of the bag 40′ is grasped about the handle 20 by the user while sliding the animal droppings onto the scoop 15 covered by the bag 40′. As the user gathers the animal waste the force exerted on the animal waste removal device 10 maintains the closed end of the bag against the distal end 10b of the scoop 15. Since the scoop 15 has a blunt distal end 10b the closed end of the bag will not puncture or tear while gathering the animal waste. Once the animal droppings have been accumulated on the scoop 15 covered by the bag 40′, the user while holding the handle 20 maintains the animal waste removal device 10 in a substantially horizontal position to prevent the accumulated animal waste from sliding off the scoop. The user then grasps the open end of the bag with their other hand and pulls back the open end of the bag from the proximal end 15b towards the distal end 15a of the animal waste removal device 10 thereby turning the entire bag inside out while enclosing the animal waste inside the bag without contacting the user's hands or the scoop 15, as shown in FIG. 5. With the animal waste 45 disposed inside the bag 40′ the user can secure the open end, for example, using a knot or twist tie, and discard the used bag in a proper trash receptacle (FIG. 6).

One particular advantageous feature of the present invention is the fact the scoop never directly comes into contact with the animal waste and thus remains free from debris. In addition, the user's hands while disposing of the bag never have to come into contact with the animal waste itself which is supported at all times by the scoop 15. Once the animal waste removal device 10 is inserted into the bag 40′ with the blunt distal end 10b proximate the closed end of the bag 40′, any shifting of the bag will not require repositioning during or after gathering of the animal waste. Accordingly, the present invention solves the problems associated with conventional animal waste removal devices.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

Every issued patent, pending patent application, publication, journal article, book or any other reference cited herein is each incorporated by reference in their entirety.

1. A system for removal of animal waste, comprising:
a waste removal device including:
a scoop for gathering the animal droppings; and
a handle connected to the scoop, the handle having a cavity defined therein adapted in size and dimension to receive a plurality of unused bags and a releasable closure for retaining unused bags in the cavity of the handle.

2. The system in accordance with claim 1, wherein the unused bags are formed into a roll and the cavity is adapted in dimension and shape to accommodate the roll.

3. The system in accordance with claim 1, wherein the handle includes an aperture defined through its exterior in communication with the cavity, the aperture being adapted in dimension and shape to dispense one at a time therethrough one of the plural unused bags.

4. The system in accordance with claim 1, wherein the scoop has a bottom wall onto which the animal waste is slid and side walls extending therefrom but does not have an upper wall.

5. The system in accordance with claim 4, wherein the surface area defined by the bottom wall is greater than the surface area of all the side walls combined.

6. The system in accordance with claim 1, wherein each bag is adapted in dimension substantially equal to that of the waste removal device.

7. The system in accordance with claim 1, wherein the closure is disposed on the proximal end of the handle opposite that of the scoop for closing off the cavity.

8. The system in accordance with claim 1, wherein the waste removal device is an integral device formed from molded plastic.

9. The system in accordance with claim 1, wherein the distal end of the scoop is blunt.

10. A method of collecting animal waste using a waste removal device including a scoop and a handle connected thereto, comprising the steps of:
inserting the waste removal device into an unused disposable bag until the distal end of the waste removal device is proximate a closed end of the bag;
scooping the animal waste using the scoop covered by the bag thereby imposing a force on the closed end of the bag retaining it against the distal end of the scoop; and
turn the bag inside out by pulling the open end of the bag over itself until the closed end of the bag thereby enclosing the animal waste therein.

11. The method in accordance with claim 10, prior to the inserting step, dispensing a single unused bag from a cavity defined in the handle, the cavity is adapted in dimension and shape to receive a plurality of unused disposable bags.

12. The method in accordance with claim 11, wherein the dispensing step comprises the steps of:
opening a closure sealing off the cavity; and
removing a single unused disposable bag from the cavity.

13. The method in accordance with claim 12, wherein the plurality of unused disposable bags are formed in a roll and the removing step comprises unwinding an outer bag from the roll of unused disposable bags.

14. The method in accordance with claim 11, wherein the dispensing step comprises pulling a single unused bag from an aperture defined through the exterior of the handle in communication with the cavity.

15. The method in accordance with claim 10, wherein the distal end of the scoop is blunt.

16. The method in accordance with claim 10, wherein the scoop has a bottom wall onto which the animal waste is slid and side walls extending therefrom but does not have an upper wall.

17. The method in accordance with claim 16, wherein the surface area defined by the bottom wall is greater than the surface area of all the side walls combined.

18. The method in accordance with claim 10, wherein each bag is adapted in dimension substantially equal to that of the waste removal device.

19. The method in accordance with claim 12, wherein the closure is disposed on the proximal end of the handle opposite that of the scoop for closing off the cavity.

20. The method in accordance with claim 10, wherein the inserting step further comprises retaining the bag against the handle while scooping the animal waste.
